(19) United States
(12) Patent Application Publication
(10) Pub. No.: US 2004/0011588 A1
(43) Pub. Date: Jan. 22, 2004

(54) Hands-free attachment

(76) Inventor: Simon Sheldon, Grantham (GB)

Correspondence Address: DOBRUSIN & THENNISCH PC, 401 S OLD WOODWARD AVE, SUITE 311, BIRMINGHAM, MI, 48009, US

(21) Appl. No.: 10/240,693

(22) PCT Filed: Apr. 3, 2001
(86) PCT No.: PCT/EP01/03897

(30) Foreign Application Priority Data
Apr. 6, 2000 (GB) 00084442

(51) Int. Cl. G10K 11/00; H04R 25/00

(52) U.S. Cl. 181/128; 181/20

(57) ABSTRACT

A hands-free attachment for a radio telephone, comprising a transducer connectable to the receiver to generate sound waves representing sound signals received by the receiver, and electrically non-conductive means for conveying the sound waves from the transducer to an ear-piece locatable in or adjacent to the user's ear, the system preferably includes a remote microphone.

### FIELD OF THE INVENTION

This invention relates to a hands-free attachment for telecommunication devices such as a mobile telephone.

### BACKGROUND TO THE INVENTION

Cellular telephones, like radio telephones and two-way radio devices typically consist of a hand-held unit which is held to the user's head in use. Each unit typically comprises a microwave transmitter connected to an antenna mounted on the end of the unit, and is thus held in close proximity to the user's head. Although the energy in the microwaves radiated from the antenna is very small, there are fears that prolonged use carries a risk of harm to the user's brain, for example inducing brain tumours.

To meet these fears, so-called ‘hands-free’ attachments have been developed for radio telephones. These typically consist of an ear-piece containing a small transducer, and a microphone which can be clipped to the user's clothing near to the mouth. The ear-piece and the microphone are connected by wires to the body of the telephone, which can then be operated away from the user's head.

However, recent research has suggested that there is still a risk of exposure of the user's brain to microwave radiation when such attachments are used, because of induction of microwave radiation into the wires, the wire leading to the ear-piece then re-radiating close to the head and so still giving rise to some risk to the user's brain.

There is thus a need for a system which significantly reduces or eliminates the radiation of microwave energy close to the head of the user.

### SUMMARY OF THE INVENTION

According to the invention, there is provided a hands-free attachment for a radio telephone, comprising a transducer connectable to the receiver to generate sound waves representing sound signals received by the receiver, and electrically non-conductive means for conveying the sound waves from the transducer to an ear-piece locatable in or adjacent to the user's ear.

The receiver is preferably a telephone, particularly a mobile telephone. The transducer is preferably connectable electrically to the telephone although it may be connectable optically to, for example, receive signals from the receiver by infra red transmission. The transducer may be part of the receiver, within the receiver-housing or attached to the receiver or alternatively it may be separate with a remote connection.

The electrically non-conductive means preferably comprises a tube, for example of a flexible plastics material. The tube is suitably sufficiently flexible to permit it to pass from, say, a pocket in which the telephone is located to the person's ear, while being sufficiently rigid-walled to prevent collapse of the tube as it curves. The tube should be manufactured of a suitable material and have an appropriate internal surface texture to minimise acoustic loss as the soundwaves are conveyed from the transducer to the ear-piece. Examples of suitable materials include thermoplastics such as polyolefines and polyamides, ceramics, fabrics or rubbers such as silicone rubber. Thermoplastics are preferred as they are easy to process by, for example, extrusion and are durable.

The transducer may be contained in a unit attachable directly to the telephone body so as to form an extension thereof, or it may be connected to the telephone by a plug and cable, permitting it to be located conveniently away from the telephone and thus avoid any risk of audio feedback to the telephone (although means could be incorporated to switch off the telephone's integral microphone when the unit is attached). The transducer unit may, if necessary, incorporate an amplifier to ensure that the volume of sound transmitted along the tube is sufficient to ensure audibility for all users. Volume control means may also be incorporated to allow the level of sound at the ear-piece to be adjusted to suit individual users.

The transducer unit may be housed in a plastics casing, for example, and may be provided with a clip to permit its temporary attachment to the user's clothing, for example at a short distance from the microphone, perhaps of the order of 100 to 500 mm particularly 100 to 200 mm.

The ear-piece may be a separate device attachable to the sound conveyor or it may be part of the sound-conveying device. The ear-piece may be adapted to be usable with hearing aids, for example by means of an adapter to permit direct connection of a sound conveying tube to the aid. In this way the attachment of the invention may be used by those with impaired hearing which may bring an added benefit of providing improved audibility compared with the use of a traditional mobile telephone.

In a preferred embodiment the system of the present invention further includes a microphone attachment to enable the user to speak at a distance from the receiver which in this instance will also be a transmitter. As is, of course, normal with mobile telephones and two way radio devices. The microphone may be connected to the telephone by wires in conventional manner, since the wires do not pass close to the brain in the same way that the ear-piece wires in a conventional hands-free attachment will. However, if desired, the microphone may be located at a position remote from the user's head and provided with sound conveying device such as a tube extending to a position adjacent to the user's mouth, the requirement for such a tube are similar to those set out above, for conveying sound to the ear-piece. The microphone may then be connected to the telephone by wires or by optical means. It will typically be desirable to keep the microphone separate from the transducer to avoid the risk of audio feedback from the latter to the former.

The attachment of the invention provides a simple and convenient way of keeping the source of microwave radiation well away from the user's head whilst providing all the functionality of the currently-available wired attachments.

The means for attaching the hands-free attachments of the present invention to receiver/transmitters preferably use standard connectors so that the attachments are interchangeable enabling the hands-free attachment of the present invention to be interchangeably used on different receiver/transmitter devices. In this way the hands-free attachment may be supplied separately as an independent unit or alternatively it may be supplied as a component in for example a mobile telephone kit. The hands-free attachment may also be configured in a way that enables its battery to be charged at the same time as, for example, the battery of a mobile telephone is being charged. Similarly the transducer unit may be provided with a warning device to indicate when its battery is low.

### BRIEF DESCRIPTION OF THE DRAWING

FIG. 1 is a diagrammatic representation of a cellular telephone with an attachment in accordance with an exemplary embodiment of the invention.

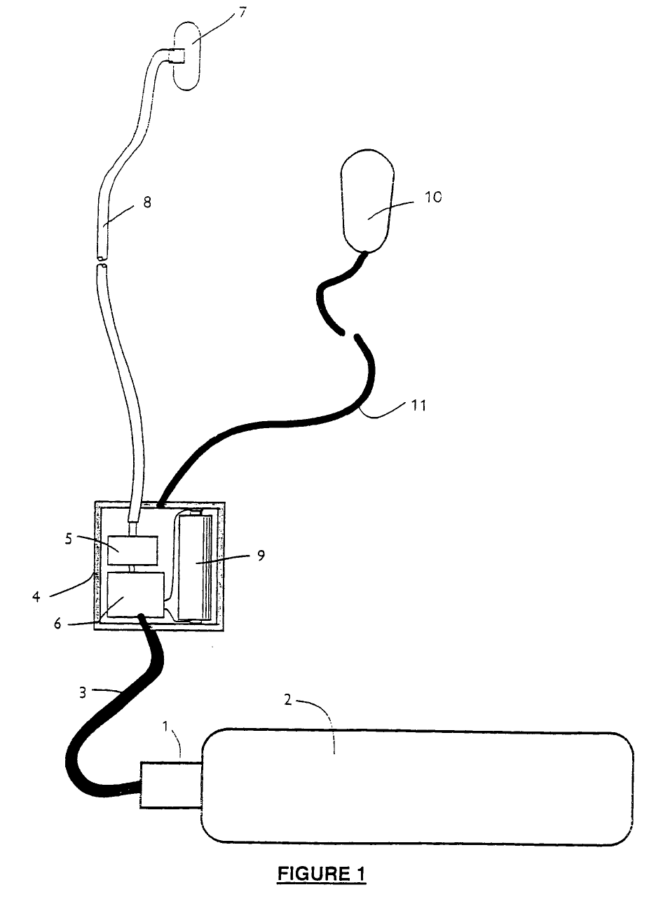

### DETAILED DESCRIPTION OF THE ILLUSTRATED EMBODIMENT

The attachment comprises a plug 1 which connects with a conventional attachment socket in the base of a cellular telephone 2 and which is connected via a short cable 3 to a connector unit 4. The connector unit 4 contains a transducer 5 which converts the electrical signals from the telephone, amplified in an amplifier 6, into audio frequency vibrations which are transmitted to an ear-piece 7, which fits into the user's outer ear in conventional manner, through a flexible plastics tube 8. The amplifier is supplied with power from a battery 9 contained within the unit. In an alternative arrangement, power to drive the amplifier is supplied from the telephone via the cable 3. A separate microphone 10 is connected through a wire 11 to the unit 4 and in turn by the cable 3 to the telephone 2. The microphone may be provided with a clip to permit it to be attached to the wearer's clothing at a convenient position adjacent to the user's mouth, in conventional manner,

The tube 8 and the wire 11 are both shown broken for convenience of illustration; it will be understood that in practice they are both continuous.

The cable 3 may be extended to permit the unit 4 to be located remotely from the telephone 2, for example in a different pocket to that in which the telephone is located, or clipped to an item of the user's clothing.

The tube 8 may be permanently attached to the unit 4, or may be detachable from it, for example to permit its replacement if damaged. Equally, the ear-piece 7 may be detachably connected to the tube 8, for example by a simple push-on connection, so that it may be readily replaced, for example to permit different users to share a telephone, or to share the attachment, hygienically.

To permit adjustment of the power output from the amplifier, the unit 4 may be provided with a slideable or rotateable rheostat control. To conserve battery power when the device is not in use, a power switch may be provided on the unit.

1. A hands-free attachment for a radio telephone, comprising a transducer connectable to the receiver to generate sound waves representing sound signals received by the receiver, and electrically non-conductive means for conveying the sound waves from the transducer to an ear-piece locatable in or adjacent to the user's ear.

2. A hands-free attachment according to claim 1, in which the receiver is a mobile telephone.

3. A hands-free attachment according to claim 1 or claim 2, in which the transducer is electrically connectable to the receiver.

4. A hands-free attachment according to claim 1 or claim 2, in which the transducer is optically connectable to the receiver.

5. A hands-free attachment according to any of the preceding claims, in which the transducer is within the receiver-housing.

6. A hands-free attachment according to any of claims 1 to 4, in which the transducer is separate from the receiver-housing and employs a remote connection.

7. A hands-free attachment according to any of the preceding claims, in which the electrically non-conductive means for conveying the sound waves is a tube.

8. A hands-free attachment according to claim 7, in which the tube is sufficiently flexible to pass from a pocket to the users ear whilst being sufficiently rigid to prevent collapse as it curves.

9. A hands-free attachment according to claim 7 or claim 8, in which the tube is of a thermoplastic material.

10. A hands-free attachment according to any of the preceding claims, in which the transducer is contained in a unit attachable directly to the telephone body so as to form an extension thereof.

11. A hands-free attachment according to any of claims 1 to 9, in which the transducer is connected to the receiver by a plug and cable, permitting it to be located conveniently away from the telephone and thus avoid any risk of audio feedback to the telephone.

12. A hand-free attachment according to any of the preceding claims, in which the transducer unit incorporates an amplifier.

13. A hands-free attachment according to any of the preceding claims, also containing a volume control means.

14. A hands-free attachment according to any of the preceding claims, in which the ear-piece is a separate device attachable to the sound conveyor.

15. A hands-free attachment according to any of the preceding claims, in which the ear-piece is adaptable to be usable with hearing aids.

16. A hands-free attachment according to any of the preceding claims, also containing a transmitter and a microphone attachment.

17. A hands free attachment according to claim 16, in which the transmitter is contained within the receiver housing.

18. A hands-free attachment according to claim 16 or claim 17, in which the microphone attachment is connected to the receiver/transmitter by wires.

19. A hands-free attachment according to any of claims 16 to 18, in which the microphone is adapted to be located at a position remote from the users head and provided with a sound conveying device to transmit sound from the user to the microphone.

20. A hands-free attachment according to claim 19, in which the sound conveying device is a tube.

21. A hands-free attachment according to claim 20, in which the tube is of a thermoplastic material.

22. A hands-free attachment according to any of the preceding claims, configured in a way that enable the battery of the hands-free attachment to be charged at the same time as, for example, the battery of a mobile telephone is being charged.
